(19) United States
(12) Patent Application Publication
(10) Pub. No.: US 2005/0275745 A1
(43) Pub. Date: Dec. 15, 2005

(54) Quick focusing method for a digital camera

(75) Inventor: Hsin-Hung Hsu, Taipei City (TW)

Correspondence Address: TROXELL LAW OFFICE PLLC, 5205 LEESBURG PIKE, SUITE 1404, FALLS CHURCH, VA, 22041, US

(73) Assignee: Premier Image Technology Corporation

(21) Appl. No.: 10/863,213

(22) Filed: Jun. 9, 2004

(51) Int. Cl. G03B 13/24; H04N 5/232; G03B 13/00; G03B 17/00

(52) U.S. Cl. 348/351; 396/79

(57) ABSTRACT

A quick focusing method for a digital camera calculates a plurality of resolutions corresponding to a plurality of view-finding locations. The method finds a location for the optimal location by comparing the resolutions and determines the optimal location with reference to the slopes of lines connecting those view-finding locations. The quick focusing method can advantageously reduce focusing time.

### FIELD OF THE INVENTION

The present invention relates to a quick focusing method for a digital camera, and especially to a quick focusing method for a digital camera that uses fewer view-finding locations, thus decreasing focusing time.

### BACKGROUND OF THE INVENTION

In accord with the rapid progress of digital electronic and semiconductor process, many conventional consumer products are digitalized. For example, digital imaging devices such as digital still cameras (DSC) and digital video cameras (DV) are becoming increasingly mature and popular.

The digital still camera uses electronic imaging device such as a CCD (charge coupled device) to replace conventional film for image capture. Moreover, focusing lens is also crucial component in a digital still camera and is generally controlled by a step motor. FIG. 1 shows a flowchart of the control process for a prior art focusing lens by a step motor in 50 pitches. In other words, the focusing lens is moved forward or backward 50 pitches with a step motor.

In step 101, the focusing lens is moved forward (or backward) with the step motor by one pitch for a first view-finding of an object. In step S103, the electronic imaging device such as a CCD is exposed. In step S105, the photo resolution for first-time view-finding is calculated. Step S107 determines whether the focusing lens can be further moved forward (or backward). If the focusing lens can be further moved, the procedure goes to step S101 for view-finding again (S101), exposing again (S103) and resolution calculating again (S105). If the focusing lens cannot be moved, the focusing lens has already been moved forward or backward 50 pitches by the step motor. Step S109 subsequently determines the optimal resolution to provide the optimal view-finding location among the 50 pitches.

However, in above-mentioned procedure to control the focusing lens, the steps of view finding, exposing and resolution calculating must be repeated for each movement of lens by the step motor. This is time consuming, especially in the step of exposing the electronic imaging device such as a CCD.

### SUMMARY OF THE INVENTION

It is an object of the present invention to provide a quick focusing method for a digital camera that uses less focusing time for obtaining an optimal location of the image-fetching unit.

To achieve the above object, the present invention provides a quick focusing method for a digital camera to move an image-fetching unit to an optimal location by a step motor, the method comprising the steps of a) moving the image-fetching unit to a first view-finding location, a second view-finding location and a third view-finding location, respectively, with the step motor; b) calculating a first resolution corresponding to the first view-finding location, a second resolution corresponding to the second view-finding location and a third resolution corresponding to the third view-finding location; c) determining a location for the optimal location by comparing the three resolutions; and d) determining the optimal location by the first view-finding location, the second view-finding location and the third view-finding location.

### BRIEF DESCRIPTION OF DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a flowchart describing the view-finding process according to the prior art;

FIG. 2 shows a perspective view of a conventional digital still camera;

FIG. 3 shows the resolution curve corresponding to the first embodiment of the present invention;

FIG. 4 shows the slope curve corresponding to the first embodiment of the present invention;

FIG. 5 shows the resolution curve corresponding to the second embodiment of the present invention;

FIG. 6 shows the slope curve corresponding to the second embodiment of the present invention;

FIG. 7 shows the resolution curve corresponding to the third embodiment of the present invention;

FIG. 8 shows the resolution curve corresponding to the fourth embodiment of the present invention;

FIG. 9 shows the resolution curve corresponding to the fifth embodiment of the present invention;

FIG. 10 shows the resolution curve corresponding to the sixth embodiment of the present invention;

FIG. 11 shows the resolution curve corresponding to the seventh embodiment of the present invention; and

FIG. 12 shows the flowchart of the quick focusing method for a digital camera according to the present invention

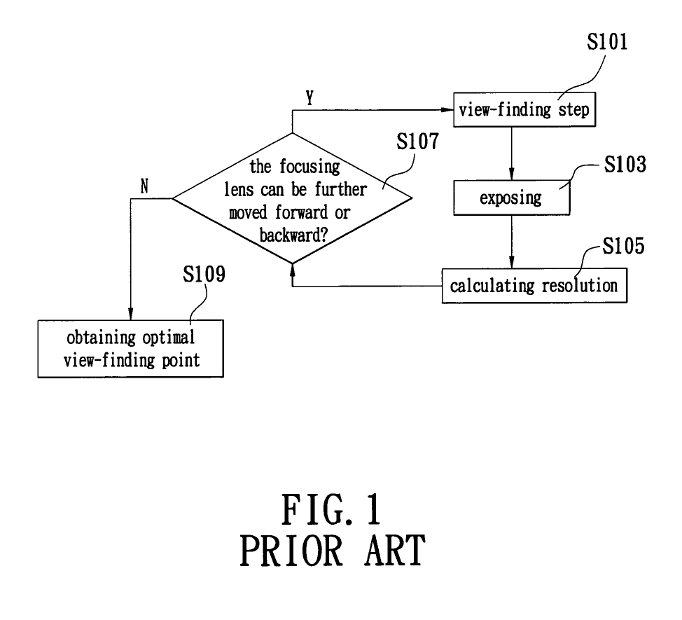

### DETAILED DESCRIPTION OF THE INVENTION

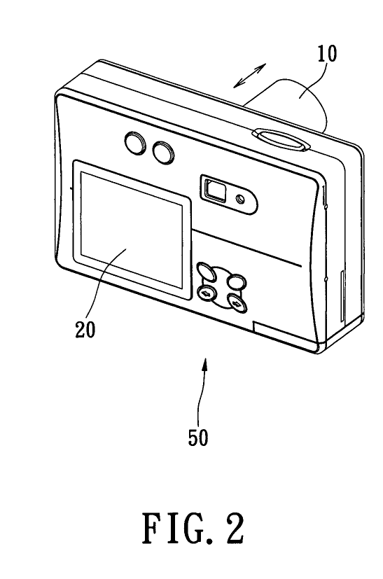

FIG. 2 shows a perspective view of a digital still camera (DSC) 50, which comprises a step motor (not shown) to move an image-fetching unit 10 such as a lens, such that a taken picture can be displayed on a display 20.

The present invention presets a plurality of view-finding locations along a movement path of the image-fetching unit 10 for taking photos. Taking a motor of 100 pitches as an example, the view-finding locations in the present invention are separated by 10 pitches. Therefore, there are 10 view-finding locations on the movement path.

The above-mentioned process is to reduce exposure times of the digital still camera (DSC). The separation between the view-finding locations is fixed in above description. However, the separation between the view-finding locations can also be variable.

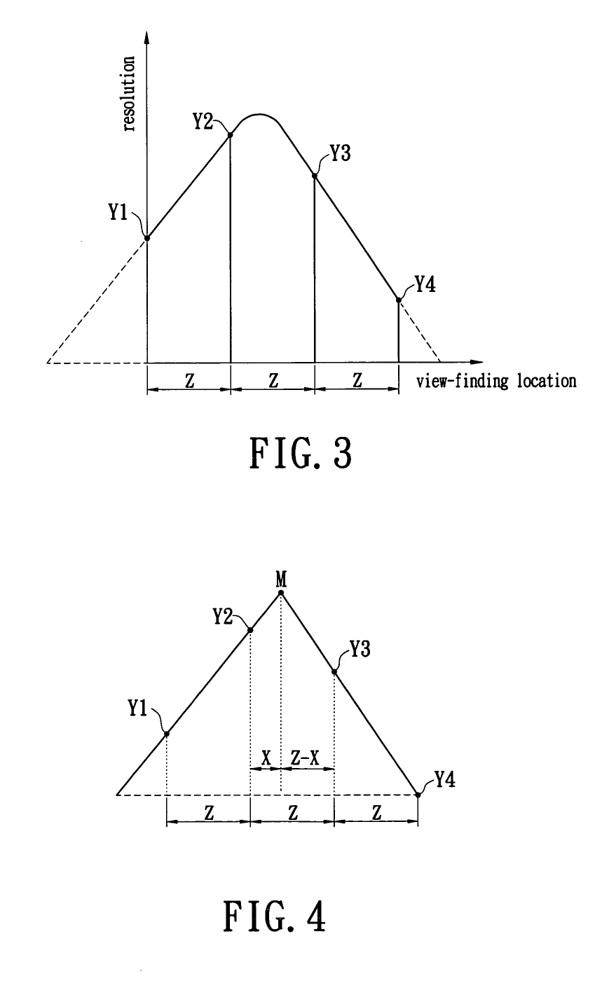

After setting up the view-finding locations, the image-fetching unit 10 calculates the resolution and contrast for the taken photo at those view-finding locations. Therefore, the optimal view-finding location can be determined and the view-finding location can be determined to be an ordinary case, a special case or a boundary case. FIG. 3 shows the resolution curve according to the first preferred embodiment of the present invention for the ordinary case, in which the ordinate is the resolution and the abscissa is the view-finding location.

After the image-fetching unit 10 is moved to the first view-finding location Y1 and second view-finding location Y2 by the step motor, the first resolution and the second resolution corresponding to the first view-finding location Y1 and second view-finding location Y2 are calculated. As shown in this figure, the second resolution is larger than the first resolution, therefore, the step motor further moves the image-fetching unit 10 beyond the second view-finding location Y2 to a third view-finding location Y3. Moreover, the third resolution corresponding to the third view-finding location Y3 is compared to the first resolution and the second resolution corresponding to the first view-finding location Y1 and second view-finding location Y2.

When the third resolution corresponding to the third view-finding location Y3 is smaller than the second resolution corresponding to the second view-finding location Y2, the resolution decreases. The third resolution corresponding to the third view-finding location Y3 is again compared with the first resolution corresponding to the first view-finding location Y1 to determine whether the optimal view-finding location is located between the first view-finding location Y1 and second view-finding location Y2, or between the second view-finding location Y2 and the third view-finding location Y3.

As shown in the example of FIG. 4, the optimal view-finding location is judged to be located between the second view-finding location Y2 and the third view-finding location Y3 because the third resolution of the third view-finding location Y3 is larger than the first resolution of the first view-finding location Y1. In the present invention, this condition is referred to as an ordinary condition and a fourth resolution is calculated by further moving the view-finding location to a fourth view-finding location Y4 beyond the third view-finding location Y3.

When the image-fetching unit 10 calculates the fourth resolution corresponding to the fourth view-finding location Y4, the view-finding location is not further moved and a slope approach is used to save focusing time. As shown in FIG. 4, a first extension line is obtained by connecting the first view-finding location Y1 and second view-finding location Y2, and a second extension line is obtained by connecting the view-finding location Y3 and fourth view-finding location Y4. The optimal location M is the intersection of the two extension lines.

As shown in FIG. 4, the four view-finding locations Y1, Y2, Y3, and Y4 have the same separation such as 10 pitches. The x between the second view-finding location Y2 and the optimal location M is an unknown value. Provided that the view-finding locations Y1, Y2, Y3, and Y4 have ordinates Y1, Y2, Y3, and Y4 and the optimal location M has an ordinate m and the fixed separation is z, the distance x can be determined as follows:

$$1. \frac{m - y1}{z + x} = \frac{m - y2}{x}$$

$$2. \frac{m - y4}{2 z - x} = \frac{m - y3}{z - x}$$

By computing the two equation,

$$x = \frac{z ( 2 y3 - y2 - y4 )}{( y2 - y1 + y3 - y4 )}$$

The optimal location M can be obtained by added x to Y2.

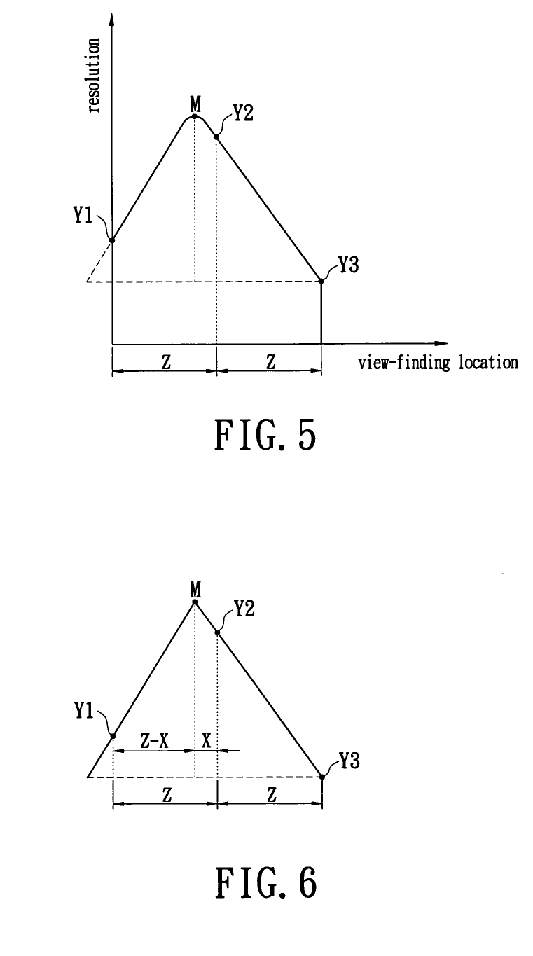

FIG. 5 shows the resolution curve corresponding to the second embodiment of the present invention, which corresponds to a special condition. As shown in this figure, the third view-finding location Y3 is smaller than the first resolution of the first view-finding location Y1. This means the resolution is decreasing and the view-finding location is not moved further.

In this special condition, the third view-finding location Y3 is smaller than the first resolution of the first view-finding location Y1. The optimal view-finding location is therefore located between the first view-finding location Y1 and second view-finding location Y2. In this case, the extension line passing the first view-finding location Y1 is assumed to have the same slope as the extension line connecting the second view-finding location Y2 and the view-finding location Y3. Therefore, the optimal location M is the intersection of the two extension lines, which are two sides of an isosceles triangle.

As shown in FIG. 5, the three view-finding locations Y1, Y2, and Y3 have the same separation z, and the optimal location M has a separation x with respect to the second view-finding location Y2. The distance x can be determined as follows:

$$\frac{m - y1}{z - x} = \frac{m - y2}{x} = \frac{y2 - y3}{z} , \\ x = \frac{z ( y1 - y3 )}{2 ( y2 - y3 )}$$

The optimal location M can be obtained by subtracting x from Y2.

Moreover, when the second resolution of the second view-finding location Y2 is larger than the first resolution of the first view-finding location Y1, the third resolution of the third view-finding location Y3 is compared with the second resolution of the second view-finding location Y2. If the third resolution of the third view-finding location Y3 is larger than the second resolution of the second view-finding location Y2, the digital camera 50 judges whether the third view-finding location Y3 is an end point of the step motor. If it is not, the second view-finding location Y2 replaces the first view-finding location Y1, the third view-finding location Y3 replaces the second view-finding location Y2 and a view-finding location Y4 beyond the third view-finding location Y3 is set as the new third view-finding location Y3.

The step mentioned above is used to judge whether the evolution should proceed in a case where the resolution is still increasing. The evolution is further moved to the next view-finding location if no end point is found.

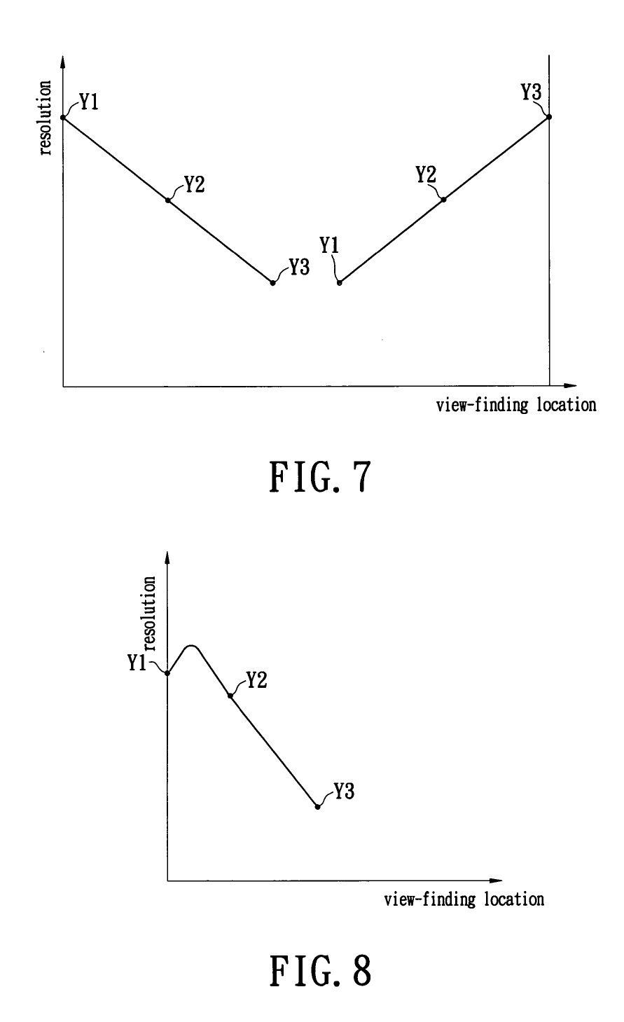

FIG. 7 shows the resolution curve corresponding to the third embodiment of the present invention, which corresponds to a boundary condition and the optimal location M is at a boundary point. The boundary point may correspond to the first view-finding location or the last view-finding location. The image-fetching unit 10 first calculates the resolution corresponding to the first view-finding location Y1, which is an initial boundary point (the first point for the step motor) and then calculate the resolutions corresponding to the second view-finding location Y2 and the third view-finding location Y3. The condition is exemplified by the resolution corresponding to the first view-finding location Y1 being larger than the resolutions corresponding to the second view-finding location Y2 and the third view-finding location Y3. The slope m1 of the line connecting the resolutions of the first view-finding location Y1 and the second view-finding location Y2 and the slope m2 of the line connecting the resolutions of the second view-finding location Y2 and third the view-finding location Y3 are compared. If m1 is equal to m2, then the first view-finding location Y1 corresponds to the optimal location M. If m1/m2 is larger than 1, the first view-finding location Y1 corresponds to the optimal location M.

As shown in right portion of FIG. 7, when the optimal location M is at the last boundary point, the criterion should be reversed. If the slope ratio of the line connecting Y1 and Y2 and the line connecting Y2 and Y3 is smaller than or equal to 1, the third view-finding location Y3 corresponds to the optimal location M.

FIG. 8 shows the resolution curve corresponding to the fourth embodiment of the present invention, in which the slope of line connecting Y1 and Y2 is smaller than the slope of line connecting Y2 and Y3. In this situation, the optimal location M is between the first view-finding location Y1 and the second view-finding location Y2 and near the first view-finding location Y1. This is similar to the special condition shown in FIG. 5 and the optimal location M can be determined by the method of isosceles triangle as shown in FIGS. 5 and 6.

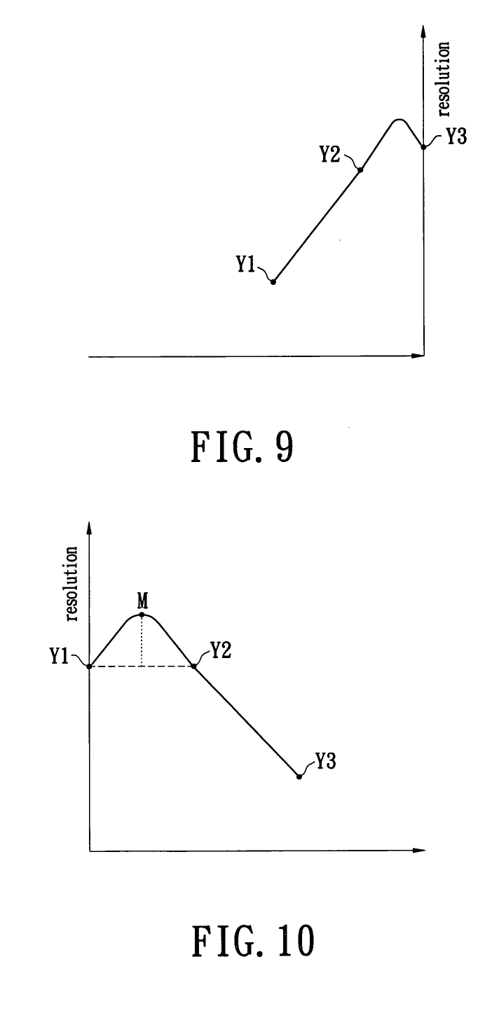

FIG. 9 shows the resolution curve corresponding to the fifth embodiment of the present invention, in which the slope of line connecting Y1 and Y2 is larger than the slope of line connecting Y2 and Y3. In this situation, the slope of line connecting Y1 and Y2 is calculated and applied to the third view-finding location Y3 by the isosceles triangle method as shown in FIGS. 5 and 6. The optimal location M is the apex of the isosceles triangle.

FIG. 10 shows the resolution curve corresponding to the sixth embodiment of the present invention, in which the slope of the line connecting Y1 and Y2 is zero. In this situation, the optimal location M is the midpoint of the first view-finding location Y1 and the second view-finding location Y2.

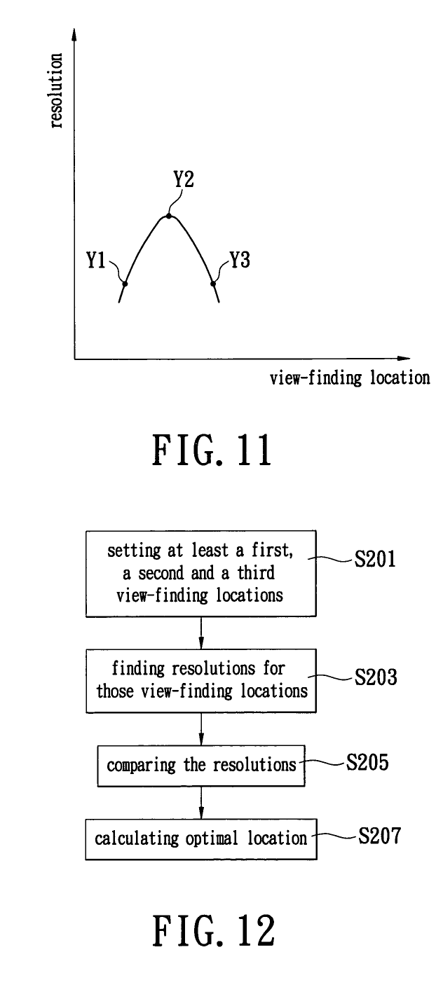

FIG. 11 shows a condition in which the optimal location M can be quickly discovered. In this situation, the resolutions of the first view-finding location Y1 and the third view-finding location Y3 are the same, but they both are smaller than the resolution of the second view-finding location Y2. The optimal location M can be quickly known at the second view-finding location Y2.

FIG. 12 shows the flowchart of the quick focusing method for a digital camera according to the present invention. At step S201, at least a first view-finding location Y1, a second view-finding location Y2 and a third view-finding location Y3 are preset for the image-fetching unit 10. In step S203, the first resolution corresponding to the first view-finding location Y1, the second resolution corresponding to the second view-finding location Y2 and the third resolution corresponding to the third view-finding location Y3 are calculated. In step S205, the resolutions are compared to determine whether the condition is an ordinary, special or boundary condition. In step S207, the optimal location is calculated by the three view-finding locations Y1, Y2 and Y3, and slope therebetween.

To sum up, the quick focusing method for a digital camera according to the present invention can quickly find the optimal location of the image-fetching unit for the digital camera. The focusing time can be reduced.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A quick focusing method for a digital camera to move an image-fetching unit to an optimal location with a motor, the method comprising the steps of:
a) moving the image-fetching unit to a first view-finding location, a second view-finding location and a third view-finding location, respectively, with the step motor;
b) calculating a first resolution corresponding to the first view-finding location, a second resolution corresponding to the second view-finding location and a third resolution corresponding to the third view-finding location;
c) determining a location for the optimal location by comparing the three resolutions;
d) determining the optimal location according to the first view-finding location, the second view-finding location and the third view-finding location.

2. The quick focusing method for a digital camera as in claim 1, wherein in step a) the first view-finding location, the second view-finding location and the third view-finding location have a same separation therebetween.

3. The quick focusing method for a digital camera as in claim 1, wherein in step a) the first view-finding location, the second view-finding location and the third view-finding location have different separations therebetween.

4. The quick focusing method for a digital camera as in claim 1, wherein step c) further comprises the substeps of:
when the first resolution is larger than the second resolution, setting the optimal location between the first view-finding location and the second view-finding location;
setting the optimal location closer to the first view-finding location when a special condition occurs; and
setting the optimal location at the first view-finding location when a boundary condition occurs.

5. The quick focusing method for a digital camera as in claim 1, wherein step c) further comprises substeps of:
when the first resolution is smaller than the second resolution, the second resolution is larger than the third resolution, and the first resolution is larger than the third resolution, setting the optimal location between the first view-finding location and the second view-finding location.

6. The quick focusing method for a digital camera as in claim 1, wherein step c) further comprises substeps of:
when the first resolution is smaller than the second resolution, the second resolution is larger than the third resolution, and the first resolution is equal to the third resolution, setting the optimal location at the second view-finding location.

7. The quick focusing method for a digital camera as in claim 1, wherein step c) further comprises substeps of:
when the first resolution is smaller than the second resolution, the second resolution is larger than the third resolution, and the first resolution is smaller than the third resolution, setting the optimal location between the second view-finding location and the third view-finding location.

8. The quick focusing method for a digital camera as in claim 1, wherein step c) further comprises substeps of:
when the second resolution is smaller than the third resolution and the third view-finding location is a last view-finding location for the step motor,
setting the optimal location between the second view-finding location and the third view-finding location, the optimal location being closer to the third view-finding location or at the third view-finding location.

9. The quick focusing method for a digital camera as in claim 1, wherein step c) further comprises substeps of:
when the second resolution is smaller than the third resolution and the third view-finding location is not a last view-finding location for the step motor,
replacing the first view-finding location with the second view-finding location;
replacing the second view-finding location with the third view-finding location;
setting a location beyond the third view-finding location as a fourth view-finding location and the replacing the third view-finding location with the fourth view-finding location; and
repeating step (b).

10. The quick focusing method for a digital camera as in claim 1, wherein step d) further comprises substeps of:
calculating a first slope of a first line connecting the second view-finding location and the third view-finding location;
forming a second line passing the first view-finding location and having a slope identical to the first slope;
finding an intersection point of the first line and the second line; and
setting the intersection point as the optimal location.

11. The quick focusing method for a digital camera as in claim 1, wherein step d) further comprises substeps of:
calculating a first slope of a line connecting the first view-finding location and the second view-finding location;
forming a second line passing through the third view-finding location and having a slope identical to the first slope;
finding an intersection point of the first line and the second line; and setting the intersection point as the optimal location.

12. The quick focusing method for a digital camera as in claim 1, wherein step d) further comprises substeps of:
setting a location beyond the third view-finding location as a fourth view-finding location;
calculating a fourth resolution of the fourth view-finding location;
finding an intersection point of a line connecting the first view-finding location and the second view-finding location and a line connecting the third view-finding location and the fourth view-finding location; and
setting the intersection point as the optimal location.
